(19) United States
(12) Patent Application Publication
(10) Pub. No.: US 2015/0138586 A1
(43) Pub. Date: May 21, 2015

(54) IMAGE FORMING APPARATUS, METHOD FOR CONTROLLING THE SAME, AND STORAGE MEDIUM STORING PROGRAM

(71) Applicant: CANON KABUSHIKI KAISHA, Tokyo (JP)

(72) Inventor: Yukiyoshi Hikichi, Tokyo (JP)

(21) Appl. No.: 14/534,553

(22) Filed: Nov. 6, 2014

(30) Foreign Application Priority Data
Nov. 19, 2013 (JP) 2013-239235

(51) Int. Cl. H04N 1/00; H04N 1/21

(52) U.S. Cl. CPC H04N 1/00076; H04N 1/00037; H04N 1/0005; H04N 1/00063; H04N 1/0009; H04N 1/00408; H04N 1/00084; H04N 1/00488; H04N 1/0049; H04N 1/2166; H04N 2201/0094
USPC 358/1.14

(57) ABSTRACT

On detection of the occurrence of an error, an image forming apparatus compares a location of an operator that is indicated by a procedure for recovering from the error with a sensed location of the operator, and issues a warning in a case where the location of the operator that is indicated by the procedure and the sensed location of the operator do not match.

### BACKGROUND OF THE INVENTION

1. Field of the Invention

The present invention relates to an image forming apparatus, a method for controlling the same, and a storage medium storing a program.

2. Description of the Related Art

Printing systems that perform high-speed and large-volume printing are required to reduce downtime due to printer failures, paper jams, and the like as much as possible. Also, in such printing systems, a large number of optional devices for feeding and discharging paper are often connected to a printer, and therefore the overall configurations of those systems are large. Thus, if a paper jam, for example, occurs in such a printing system, a large number of pieces of paper that have caused the paper jam would be left in the system. To address this issue, a list of locations of the paper that has caused the paper jam is displayed so that an operator recognizes that a large amount of paper is left in the system. However, display in list form as described above also has undesirable aspects. For example, there are cases where it is difficult for the operator to know where to start the operation for removing the jammed paper.

For example, Japanese Patent Laid-Open No. 2000-259443 proposes a method for controlling an image forming apparatus for overcoming such a drawback. Japanese Patent Laid-Open No. 2000-259443 discloses a technology that enables, in case of an error such as a paper jam, a worker to efficiently perform a recovery operation by allowing the worker to understand where the error occurs and presenting a procedure to the recovery from the error. Specifically, a technology is disclosed by which when the operator opens a front door of a paper feed cassette, the position at which the operator is currently performing the operation is detected, and the operation that should subsequently be performed is instructed to the operator by light or speech.

However, with the conventional technology, printers equipped with a large number of options like those of printing systems for the printing industry may not allow for an increase in the operation efficiency of the operator. That is to say, in such a system, a plurality of stackers and paper feeding units are connected to the printer, and therefore the operator opens and closes a large number of doors in order to check for paper. Thus, it is necessary to clearly instruct the operator which door is to be opened first. However, the conventional technology does not envisage a situation as described above. In such a system, if the operator performs an operation according to an erroneous procedure without following an instruction that indicates positions at which the operator should perform the operation, trouble such as tearing of the paper that has caused the paper jam would occur, resulting in a problem in that the time taken to recover from the error is prolonged.

### SUMMARY OF THE INVENTION

An aspect of the present invention is to eliminate the above-mentioned problems with the conventional technology.

The present invention provides a technology that prevents a situation in which jammed paper is damaged, for example, from occurring by allowing the operator, when when performing an operation for recovering from an error, to easily know where to start the operation and informing the operator of the correct operation sequence.

The present invention in its first aspect provides an image forming apparatus comprising: a sensing unit configured to sense a location of an operator; a detecting unit configured to detect an occurrence of an error; a storing unit configured to store a procedure for recovering from the error; a comparing unit configured to compare, in a case where the detecting units detects the occurrence of the error, a location of the operator that is indicated by the procedure stored in the storing unit with the location of the operator that is sensed by the sensing unit; and a warning unit configured to issue a warning in a case where, as a result of comparison by the comparing unit, the location of the operator that is indicated by the procedure and the location of the operator that is sensed by the sensing unit do not match.

The present invention has an effect of making it possible to prevent, in case of an apparatus error, trouble due to the operator starting the recovery operation from an incorrect position from occurring by judging whether the location of the operator is suitable for the recovery from the error.

Further features of the present invention will become apparent from the following description of exemplary embodiments with reference to the attached drawings.

### BRIEF DESCRIPTION OF THE DRAWINGS

FIG. 1 is a block diagram showing the configuration of a multifunctional peripheral.

FIG. 2 is a diagram showing a configuration example of a printing system aimed at the POD market and including the MFP.

FIG. 3 is a diagram for explaining a method for detecting a paper jam in the MFP.

FIG. 4 is a diagram showing an example of a screen that is displayed when paper jams are sensed by the MFP.

FIG. 5 is a top view of two printer units of the printing system.

FIG. 6 is a front view of the two printer units of the printing system.

FIG. 7 is a side view of the two printer units of the printing system.

FIG. 8 is a diagram showing the configuration of the printing system.

FIG. 9 is a flowchart illustrating a process that is performed by the MFP.

FIG. 10 is a block diagram showing a functional configuration of the MFP.

FIG. 11 shows an example of an operation information table.

FIG. 12 is a flowchart illustrating a process that is performed by the MFP.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that like components are denoted by like reference numerals, and descriptions thereof are omitted.

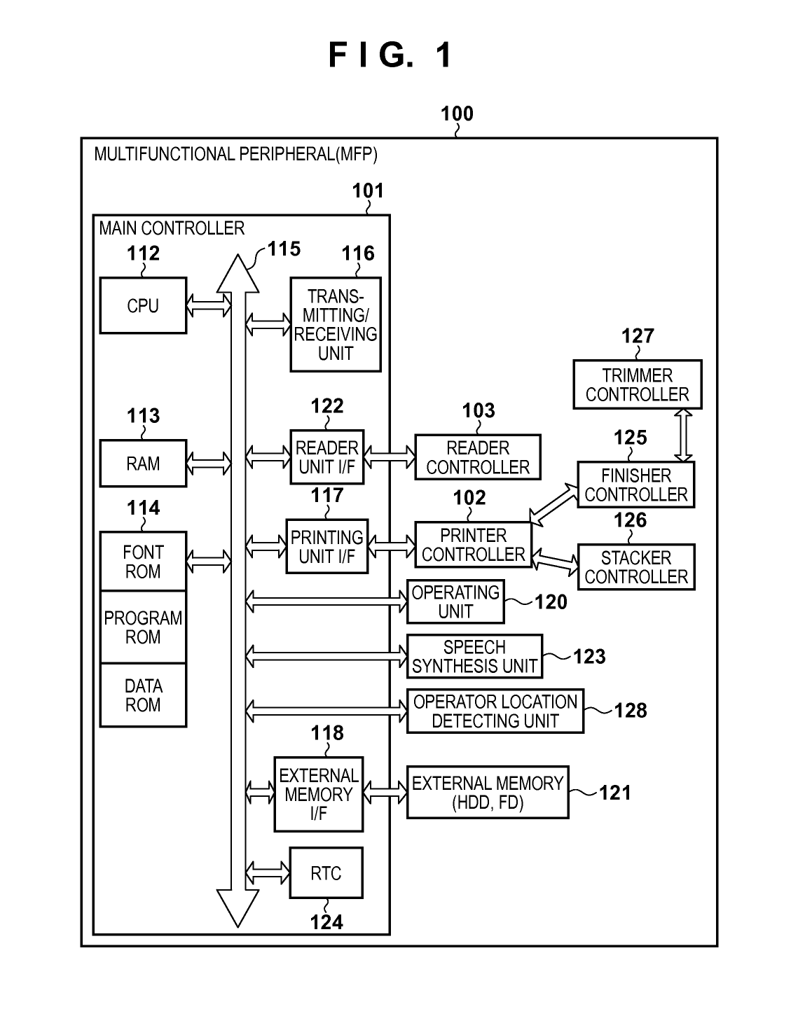

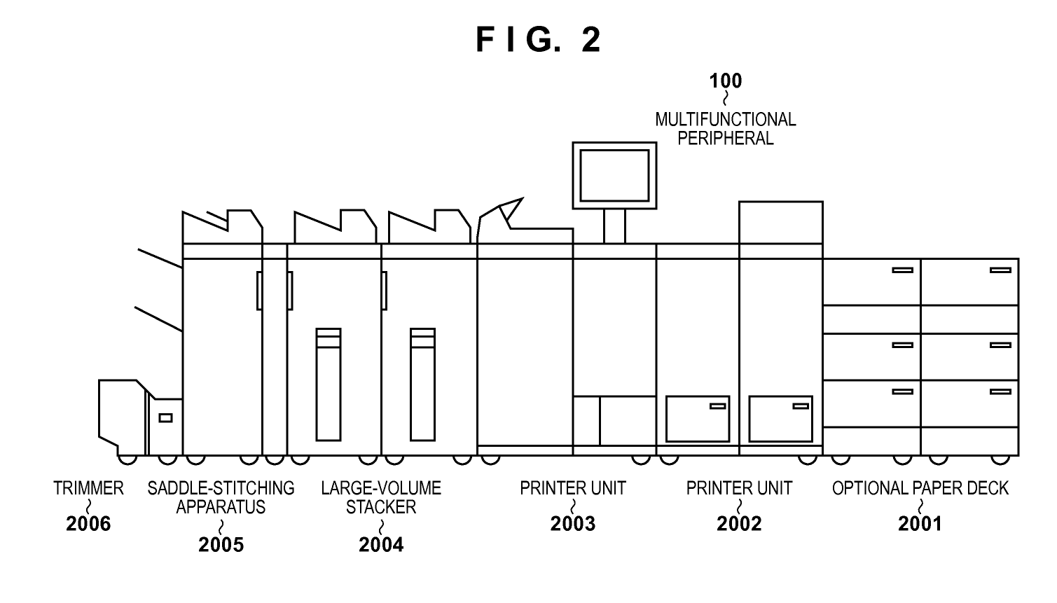

FIG. 1 is a block diagram showing the configuration of a multifunctional peripheral 100 according to an embodiment of the present invention. This multifunctional peripheral is included in a printing system (see FIG. 2), and the printing system is configured by connecting a plurality of stackers and paper feed decks, a finisher, and the like, all of which are not shown, to the multifunctional peripheral (MFP) 100.

A main controller 101 performs overall control of this MFP 100 and provides the functions of this MFP 100 using a printer controller 102, an operating unit 120, an external memory 121, and the like. A CPU 112 of the main controller 101 controls the operations of various units connected to a system bus 115 in accordance with a control program or the like that is stored in a program ROM of a ROM 114 or the external memory 121 and expanded in a RAM 113 during execution. A font ROM of the ROM 114 stores font data or the like for use in outputting display data to the operating unit 120 or outputting image data to the printer controller 102. A data ROM of the ROM 114 stores various types of setting information and the like to be referred to by a host computer (not shown) in the case where the external memory 121 such as a hard disk is not connected. The printer controller 102 forms an image by an electrophotographic process, based on an image signal sent from a printing unit I/F 117. If paper after image formation is to be subjected to post processing or the paper is to be stacked, a finisher (saddle-stitching apparatus) controller 125 or a stacker controller 126 is connected to the printer controller 102. A trimmer controller 127 is connected to the finisher controller 125 and performs trimmer processing of trimming edges of a stapled or saddle-stitched paper bundle. A reader controller 103 reads an original and obtains electronic data on that original image. The CPU 112 can acquire the electronic data on the original, which is read by the reader controller 103, via a reader unit I/F 122.

Also, the CPU 112 is configured to be able to perform communication processing with the host computer (not shown) via a transmitting/receiving unit 116 and to be able to notify the host computer of information on the printing system. The RAM 113 is used as a main memory, a work area, and the like of the CPU 112, and the memory capacity thereof can be extended using an optional RAM that is connectable to an additional port, which is not shown. Note that the RAM 113 may further be used as a region for expanding output information, a region for storing environment data, an NVRAM, and the like. Access to the aforementioned external memory 121 such as a hard disk (HD) or an IC card is controlled by an external memory I/F 118. The external memory 121 is connected as an option and stores font data, an emulation program, form data, and the like. In the operating unit 120, switches that are operable by a user, a display, and the like are arranged. The aforementioned external memory 121 is not limited to a single external memory, but includes at least one external memory, and a configuration is also possible that enables a plurality of external memories including an optional font card storing fonts additional to built-in fonts and an external memory storing a program for interpreting a printer control language of a different language system to be connected. Furthermore, an NVRAM, which is not shown, may also be provided so as to store printer mode setting information from the operating unit 120.

A speech synthesis unit 123 outputs text data stored in the ROM 114 as speech via a loudspeaker. An operator location detecting unit 128 senses the location of the operator operating this MFP 100 using a plurality of sensors (not shown) that are provided in this MFP 100. An RTC 124, which is a real-time clock circuit, is an LSI for measuring time or counting time at regular intervals. This RTC 124 is operated by power supplied from an internal battery, and therefore even in a state in which the operation of the main controller 101 is stopped due to a stoppage of power supply thereto, the RTC 124 is continuously operated. The RTC 124 generates, in accordance with a value that is written to a register of the RTC 124 from the CPU 112, an interrupt signal at predetermined points in time or at regular intervals to notify the CPU 112 of an interrupt.

FIG. 2 is a diagram showing a configuration example of a printing system aimed at the POD market and including the MFP 100 according to the embodiment.

In this example, the MFP 100 is connected to a total of four in-line sheet processing apparatuses consisting of two large-volume stackers 2004, a saddle-stitching apparatus 2005, and a trimmer 2006. Paper to be used for printing can be fed from two optional paper decks 2001, and the MFP 100 including two printer units 2002 and 2003 is connected between the paper decks 2001 and the sheet processing apparatuses.

The large-volume stackers 2004 are the sheet processing apparatuses that are capable of stacking of a large number of sheets discharged from the MFP 100. Note that 5,000 sheets can be stacked in each stacker, and a total of 10,000 sheets can be stacked by coupling the two stackers. The saddle-stitching apparatus 2005 can selectively perform stapling, punching, cutting, shift paper discharge, saddle-stitching, and folding with respect to paper that is output from the MFP 100. Furthermore, paper that has been bound by the saddle-stitching apparatus 2005 is put into the trimmer 2006, and thus trimming can be performed by which edges of the printed matter are cut flush.

On the other hand, the optional paper decks 2001 can accommodate and feed a large volume of various types of paper. Specifically, each optional paper deck 2001 is provided with two decks each capable of storing 1,000 sheets and one deck capable of storing 2,000 sheets, and can accordingly accommodate and feed a total of 4,000 sheets. Thus, a total of 10,000 sheets can be accommodated and fed when two, right and left, decks incorporated in the MFP 100 and each capable of storing 1,000 sheets are included. The MFP 100 forms an image by an electrophotographic process onto paper supplied from these paper feeders.

In the present embodiment, a method for quickly and accurately performing a process for recovery from a paper jam in the MFP 100, to which many optional devices as described above are connected, will be described.

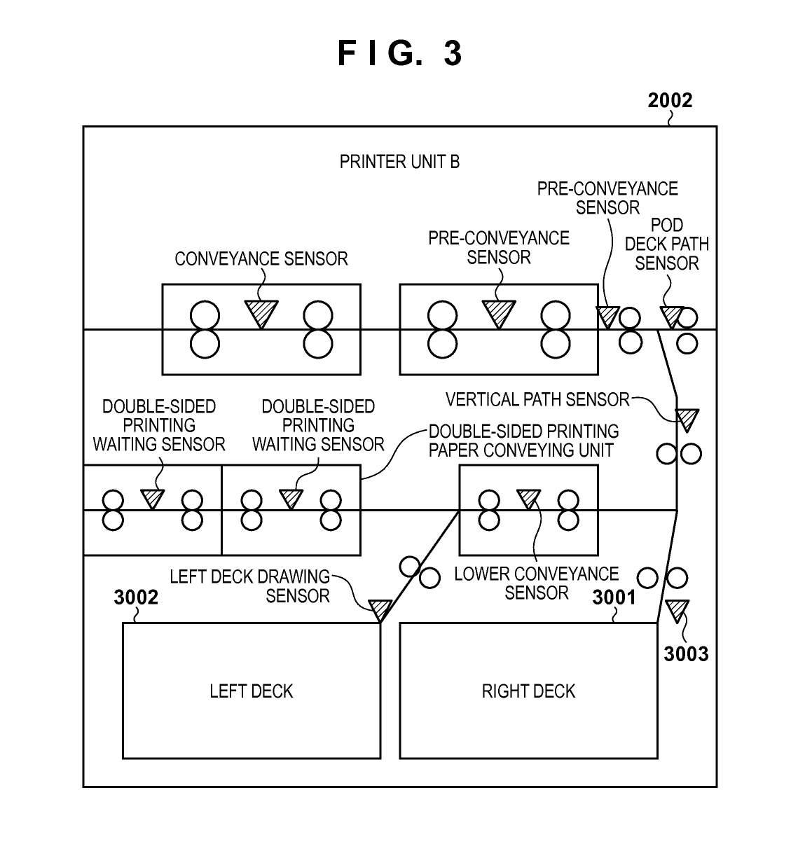

FIG. 3 is a diagram for explaining a method for detecting a paper jam in the MFP 100 according to the present embodiment. This diagram shows a cross section of the printer unit 2002 in FIG. 2.

The printer unit 2002 has the two paper decks, namely, a right deck 3001 and a left deck 3002, and conveyance rollers and paper jam sensors are arranged at various positions on paper conveyance paths. Paper jams are classified into delay jams and stay jams. Now, a case where paper is conveyed from the right deck 3001 is considered by way of example. When conveyance of paper from the right deck 3001 is started, the CPU 112 of the main controller 101 starts measuring time using the RTC 124. Then, the CPU 112 checks whether a right deck drawing sensor 3003 senses the paper within a predetermined period of time. If the sensor 3003 does not sense the paper within the predetermined period of time, the CPU 112 judges that a paper jam has occurred somewhere on the conveyance path between the right deck 3001 and the sensor 3003. In this case, the paper conveying operation is stopped on the supposition that a delay jam has occurred. On the other hand, if the right deck drawing sensor 3003 senses the paper within the predetermined period of time, the CPU 112 starts measuring time again using the RTC 124 and monitors to check whether the right deck drawing sensor 3003 no longer senses the paper within a predetermined period of time. If the sensor 3003 continues sensing the paper after the predetermined period of time has elapsed, the CPU 112 judges that a problem with paper conveyance has occurred at or downstream of the sensor 3003 and stops the paper conveying operation on the supposition that a stay jam has occurred. On sensing a paper jam in this manner, the CPU 112 stops the paper conveying operation with respect to all of the pieces of paper located in the printer unit 2002. After that, the CPU 112 checks the paper jam sensors that are installed on the paper conveyance paths in the printer unit 2002 and displays on the operating unit 120 a notification that jammed paper is located at a position where the corresponding sensor reacts.

In FIG. 3, a plurality of sensors are arranged on each paper conveyance path. All of these sensors operate in such a manner that each sensor senses paper when the paper reaches the position of that sensor and ceases to be in a state of sensing the paper once the paper moves away from the position of that sensor. The operation of these sensors is well known, and a detailed description thereof is thus omitted.

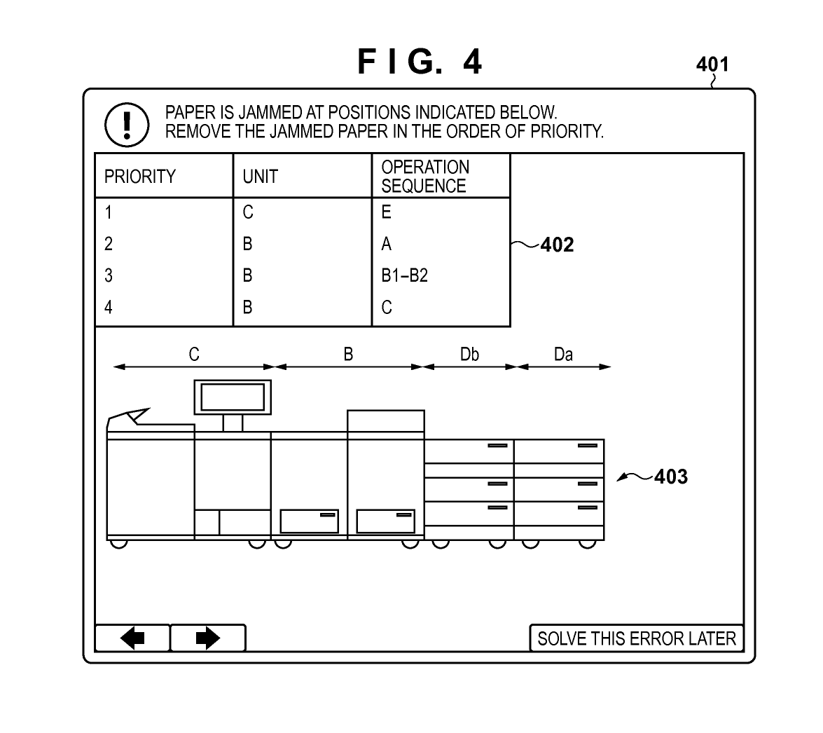

FIG. 4 shows an example of a screen that is displayed on the operating unit 120 when paper jams are sensed by the MFP 100.

When paper jams are detected in the same manner as described above with reference to FIG. 3, the main controller 101 displays how to clear the paper jams on the operating unit 120.

First, a message indicating the occurrence of the paper jams is displayed in an upper portion 401 on the screen, and under this message, the locations of the jams are displayed as a jam list 402. In this jam list 402, the upper an item in the list, the higher the priority of that item. In the example in FIG. 4, it is instructed that the paper located in a position indicated by label E in unit C, which corresponds to the printer unit 2003, should be removed first.

An illustration 403 of this printing system is displayed under the jam list 402 and shows the locations of those portions of this printing system that are indicated by respective unit numbers displayed in the jam list 402. For example, it can be seen that the printer unit 2003 is the unit C, the printer unit 2002 is the unit B, one of the optional paper decks 2001 that is located closer to the MFP 100 is the unit Db, and the other paper deck 2001 that is located further away from the MFP 100 is the unit Da.

Aside from the display in list form as described above, it is also conceivable to display the operation procedure using an animation in the order from the position of the highest priority. However, in a system that is equipped with many options like a printing system for POD and thus causes a large number of pieces of paper to remain in the apparatuses if a paper jam occurs, the display in list form as in FIG. 4 makes it easier for the operator to understand the situation due to the ability to be seen all at once.

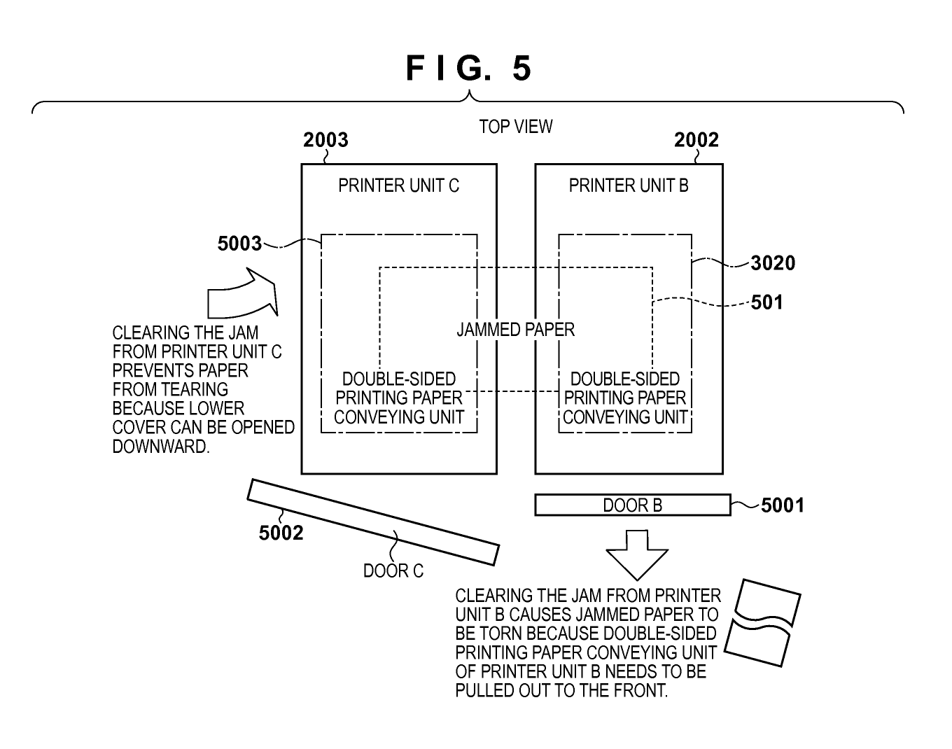

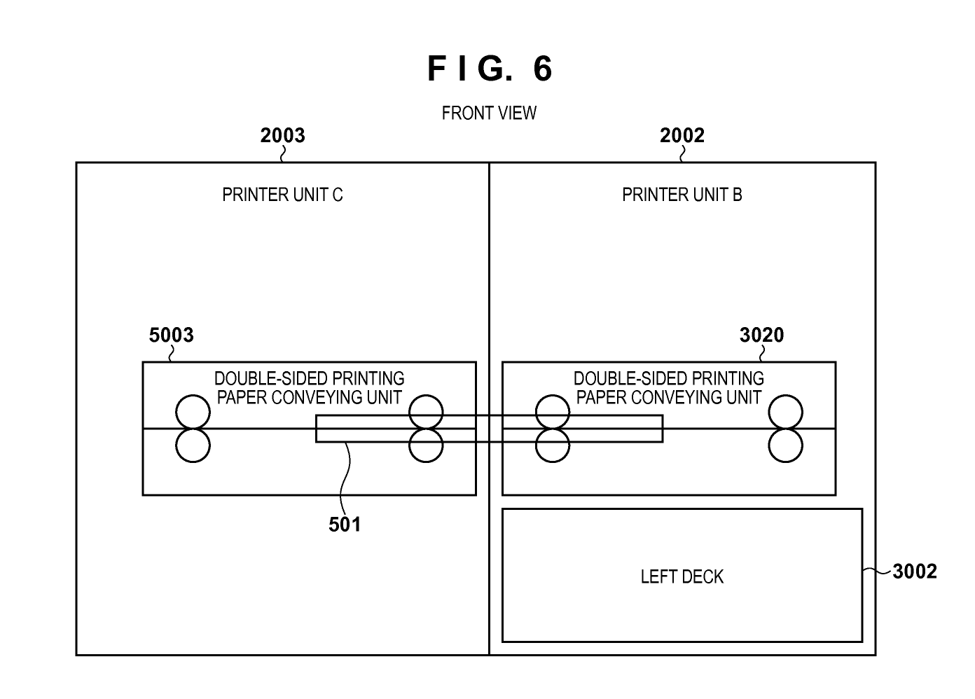

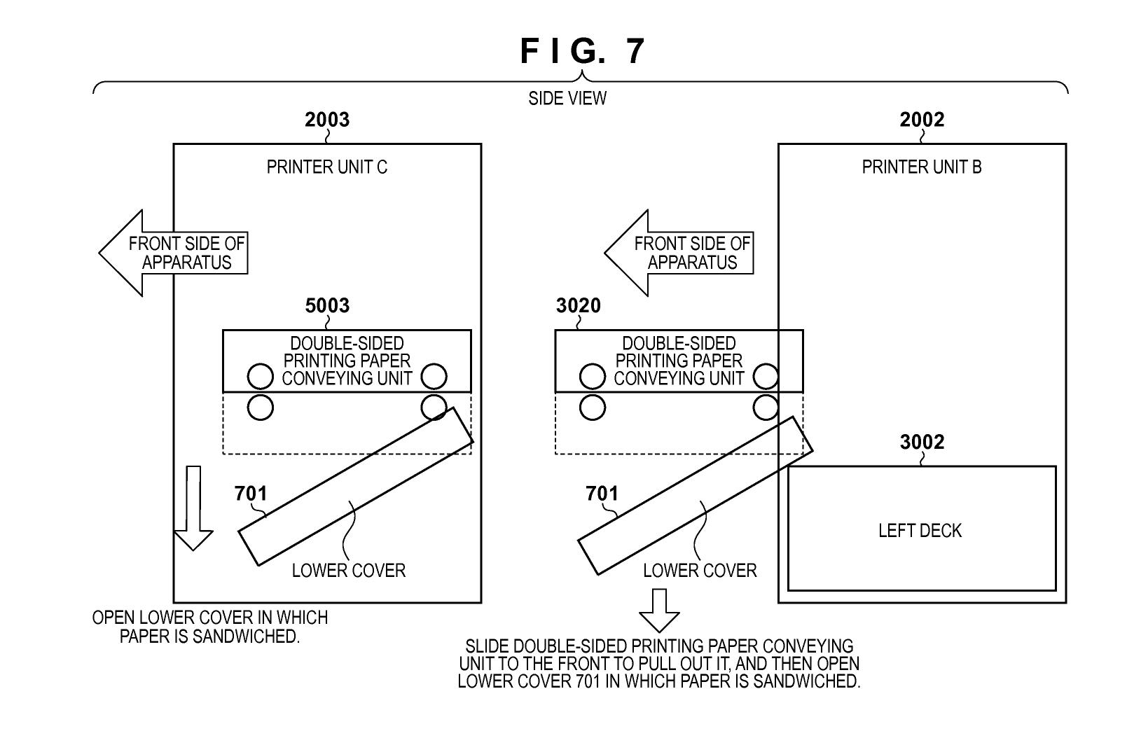

FIGS. 5 to 7 are diagrams for explaining a method for removing paper in the case where paper is jammed extending over two units in the printing system according to the embodiment. Here, in order to facilitate understanding, different views are shown in FIG. 5 (top view), FIG. 6 (front view), and FIG. 7 (side view).

With reference to the top view in FIG. 5, a case where paper 501 stays in between double-sided printing paper conveying units 3020 and 5003 of the printer unit 2002 (unit B) and the printer unit 2003 (unit C), respectively, is considered. Here, in order to remove the paper 501, it is necessary to open a door C 5002 and a door B 5001 of the respective units and remove the paper 501 from the double-sided printing paper conveying units 3020 and 5003 of the respective units. In this case, however, it is important to follow the correct order by, for example, first trying to remove the paper 501 from the printer unit 2003 (unit C) and then removing the paper 501 from the printer unit 2002 (unit B). Performing the removal in an incorrect order here would cause the paper 501 to be torn. The torn pieces of paper may be left inside the double-sided printing paper conveying units 5003 and 3020, and thus there is a possibility that a paper jam may occur again.

The reason for this is described below.

FIG. 6 is a front view of the printer unit 2002 (unit B) and the printer unit 2003 (unit C).

A lower cover of the double-sided printing paper conveying unit 5003 of the printer unit 2003 (unit C) can be lowered because there is a space under the double-sided printing paper conveying unit 5003. On the other hand, a lower cover of the double-sided printing paper conveying unit 3020 of the printer unit 2002 (unit B) cannot be lowered because the left deck 3002 is located under the double-sided printing paper conveying unit 3020.

FIG. 7 is a side view of the printer unit 2002 (unit B) and the printer unit 2003 (unit C).

As shown in FIG. 7, in the printer unit 2002, the double-sided printing paper conveying unit 3020 is pulled out to the front side before the lower cover 701 is opened downward. Accordingly, if the operation for removing of the paper 501 is started from the printer unit 2002 (unit B), the double-sided printing paper conveying unit 3020 would be pulled out with the leading edge of the paper 501 sandwiched in the double-sided printing paper conveying unit 5003 of the printer unit 2003 (unit C). As a result, the paper 501 would be split. Note that although the screen shown in FIG. 4 and indicating the operation sequence is displayed on the operating unit 120, this system is large, and thus if the operation position is away from the operating unit 120, the user is very likely to make a mistake by performing an erroneous operation procedure.

### Embodiment 1

The MFP 100 according to Embodiment 1 of the present invention has a function for preventing the operator from causing a problem as described above. In particular, if paper remains extending over both of the printer unit 2002 and the printer unit 2003 as described above with reference to FIG. 5, it is necessary to perform removal of that paper according to the correct procedure.

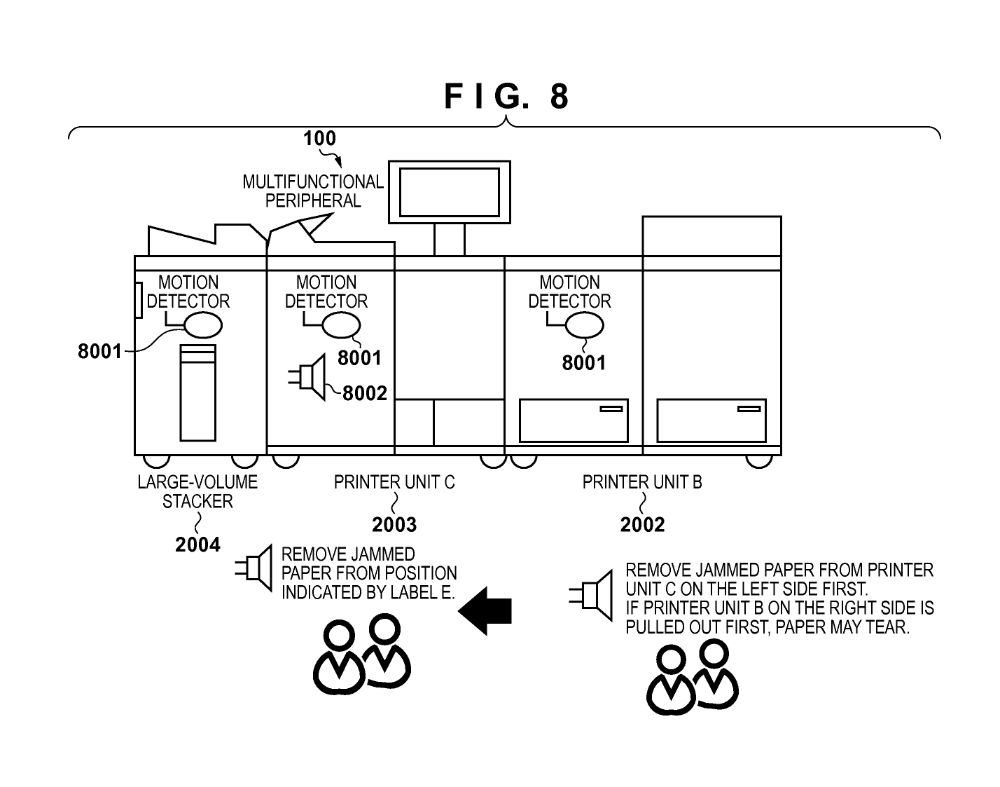

FIG. 8 is a diagram showing the configuration of a printing system according to Embodiment 1.

Here, the printing system is provided with a plurality of motion detectors 8001 and a loudspeaker 8002 for outputting speech, in addition to the above-described configuration. The motion detectors 8001 sense the presence of a person using infrared radiation, ultrasound, visible radiation, or the like. Generally, pyroelectric infrared sensors are used as the motion detectors 8001, the pyroelectric infrared sensors being capable of sensing the difference between the ambient temperature of the MFP 100 and the temperature of a person (operator) and thereby sensing the location of the operator. Here, the motion detectors 8001 are provided such that one motion detector is provided for each of the printer units 2002 and 2003, the stackers 2004, and other units.

Now assuming that the operator is standing in front of the printer unit 2002, the MFP 100 warns via the loudspeaker 8002 that the operation for removing the paper should be started from the printer unit 2003. On detecting that the operator has moved to the front of the printer unit 2003, the MFP 100 then informs the operator of the details of the paper removing operation by speech via the loudspeaker 8002, instead of issuing a warning. Thus, if the operator is going to perform an erroneous operation, the operator can realize that in advance, and accordingly the occurrence of trouble due to an erroneous operation procedure can be prevented.

Note that in FIG. 8, sentences that are shown along with the symbols indicating a loudspeaker are the speech output from the loudspeaker 8002.

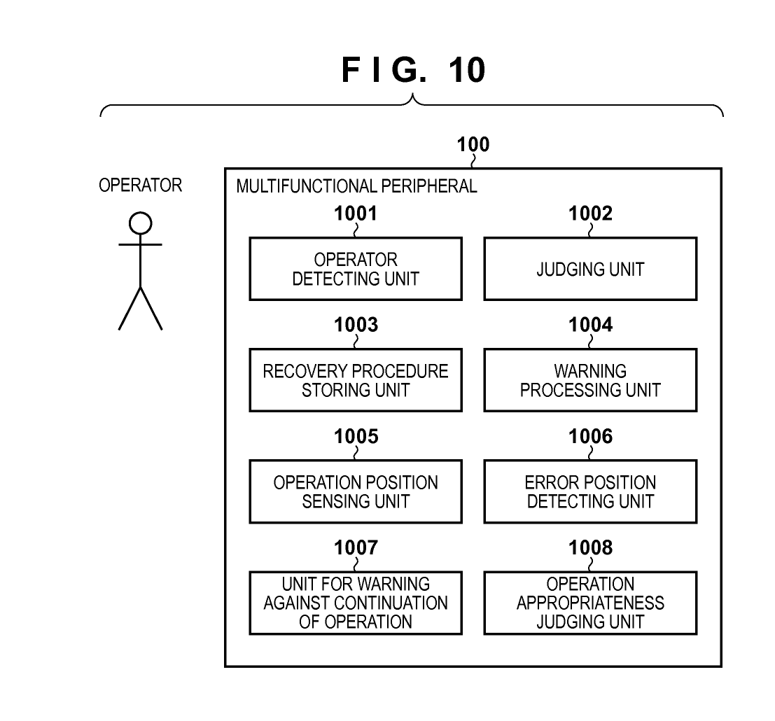

FIG. 10 is a block diagram showing a functional configuration of the MFP 100 according to Embodiment 1.

The MFP 100 has an operator detecting unit 1001 that detects the location of the operator and a recovery procedure storing unit 1003 that stores recovery procedures associated with positions at which errors such as paper jams are detected in case the errors occur. Furthermore, the MFP 100 also has a judging unit 1002 that judges whether the location of the operator is appropriate for performing the recovery operation and a warning processing unit 1004 that warns the operator if it is judged that the location of the operator is not appropriate for performing the operation. In addition, the MFP 100 also has an operation position sensing unit 1005 that senses an operation, such as a pulling-out of a unit, performed by the operator, and an error position detecting unit 1006 that detects, for example, the location of jammed paper. Note that these functions are achieved by the CPU 112 executing a program.

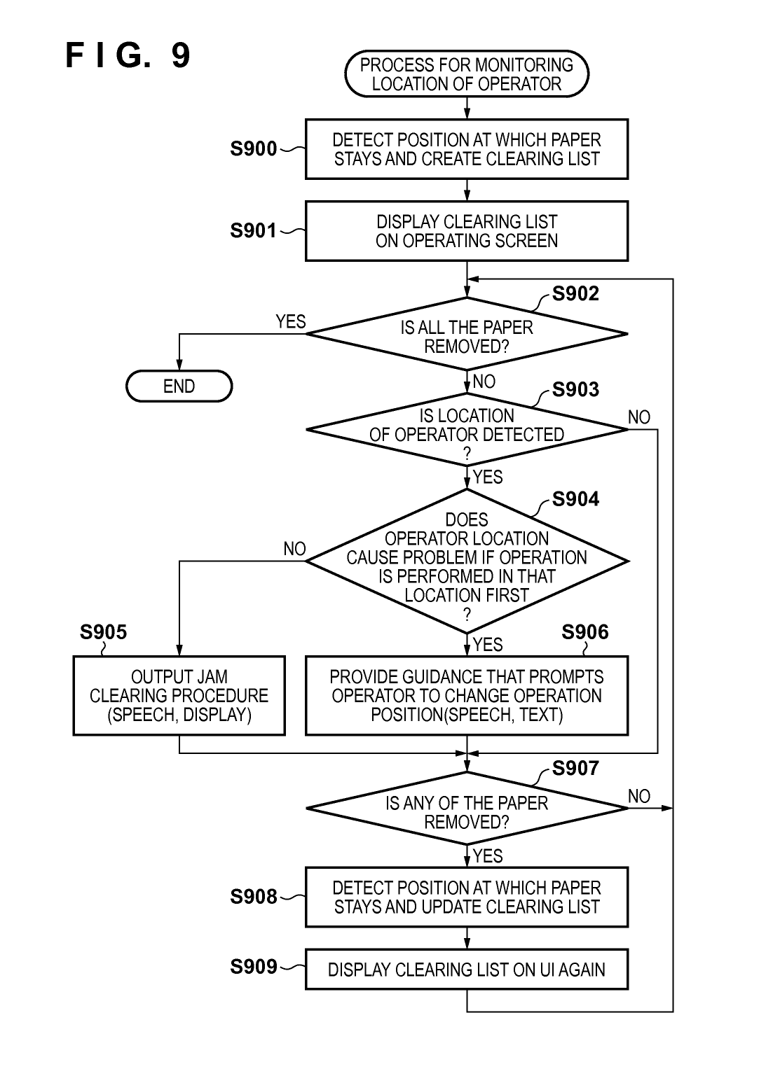

With respect to the recovery operation by the operator, a process that is performed by the MFP according to Embodiment 1 will be described with reference to a flowchart in FIG. 9. Note that the process illustrated in this flowchart is achieved by the CPU 112 expanding in the RAM 113 and executing a program stored in the program ROM or the external memory 121.

FIG. 9 is a flowchart for explaining a process that is performed by the MFP 100 according to Embodiment 1. Note that in the following description, it is assumed that the process is performed by the CPU 112.

First, in step S900, if the CPU 112 detects an error such as a paper jam, the CPU 112 creates a clearing list that specifies the procedure for recovering from that error. Subsequently, the process proceeds to step S901, and the CPU 112 displays the clearing list on the display of the operating unit 120. Subsequently, the process proceeds to step S902, and if, for example, there is a paper jam, the CPU 112 judges using the sensors on the paper conveyance paths whether all the jammed paper has been removed, that is, whether recovery from the error has been accomplished. Until it is judged here that the all the paper has been removed, processing in steps S903 to S909 is executed.

If it is judged in step S902 that any jammed paper is left, the process proceeds to step S903, and the CPU 112 judges whether the operator is sensed based on a sensing signal of the motion detector 8001. If the location of the operator is not detected in step S903, the process proceeds to step S907, while if the operator is sensed, the process proceeds to step S904, in which it is judged whether the sensed location of the operator is a suitable location for the operator to start an operation. This judgement is made by referring to an operation information table that is stored in the ROM 114. Here, the procedure that is registered in the operation information table is compared with the sensed location of the operator, and if they match, it is judged that the location of the operator is correct. On the other hand, if it is judged from the comparison result that they do not match, it is judged that the location of the operator would cause a problem if the operator starts the operation there.

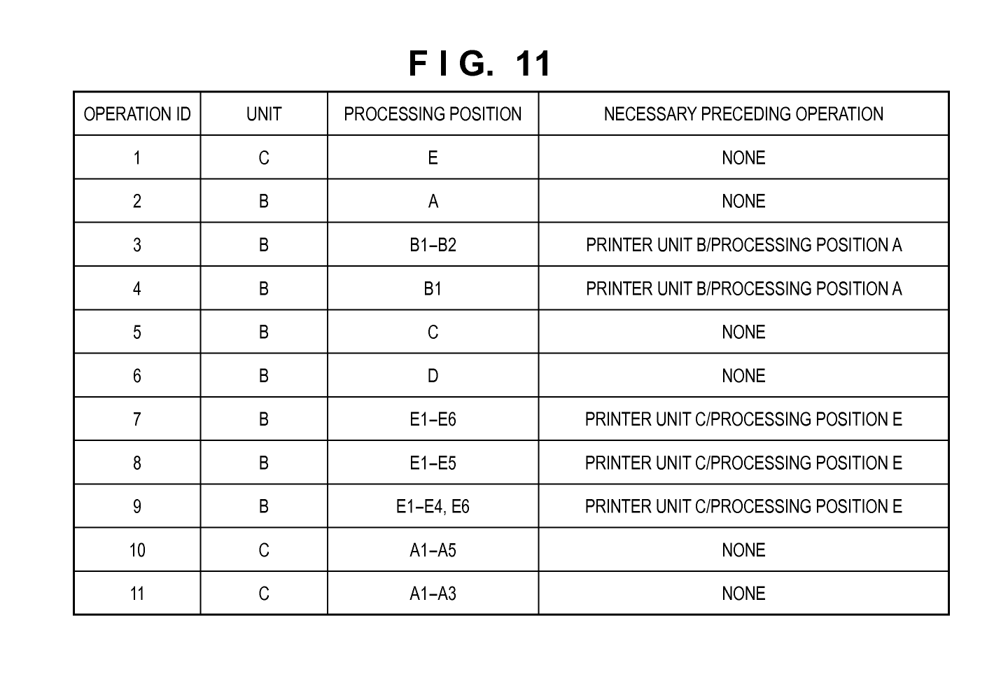

FIG. 11 shows an example of the operation information table according to Embodiment 1.

In FIG. 11, the table has the following heads: operation ID, unit, processing position, and necessary preceding operation. The operation IDs are identification information for specifying operations corresponding to errors such as, for example, jams and toner exhaustion. Under the head “unit”, for example, symbols corresponding to the various units in FIG. 4 are stored. The processing positions indicate the positions that are designated by respective labels in the various units. The necessary preceding operations indicate operations that are required to be certainly performed in advance before the above-described respective operations are performed. For example, with respect to the operation ID “7”, the operation at “processing position E” in “unit C” is registered as the necessary preceding operation for the processing positions “E1-E6” in “unit B”. This means that if the operation ID is “7”, that is, a paper jam occurs in the printer unit 2002 (unit B), it is required to certainly remove jammed paper from the printer unit 2003 (unit C) before performing the recovery operation with respect to the paper jam in the printer unit 2002 (unit B). If this order is not followed, a problem such as a tearing-off of the jammed paper would occur as described above.

In step S904, if the CPU 112 judges that a problem such as a tearing of paper would occur if the operator starts the paper removing operation from the unit in front of which the operator is located, the process proceeds to step S906, and the CPU 112 warns the user. In this case, the CPU 112 uses the speech synthesis unit 123 and warns the operator that the operator should change the operation position by speech. At the same time, the warning may also be displayed on the operating unit 120. On the other hand, in step S904, if the CPU 112 judges that the current location of the operator is the location in which the operator can perform the operation without causing any problem, the process proceeds to step S905, and the CPU 112 outputs the procedure for clearing the jam by speech. Moreover, at the same time, the procedure may also be displayed on the operating unit 120. If step S905 or S906 is executed in this manner, the process proceeds to step S907, and the CPU 112 judges whether or not any of the paper that has caused the error has been removed, and if none of the paper has been removed, the process returns to step S902. In step S907, if any of the paper has been removed, the process proceeds to step S908, and the CPU 112 updates information on the clearing list based on information on the position with respect to which the paper sensing status has changed. Subsequently, the process proceeds to step S909, in which the CPU 112 updates the clearing list that is displayed on the operating unit 120, and then the process proceeds to step S902. The above-described processing is repeatedly executed until all the jammed paper is removed.

Note that although the flowchart in FIG. 9 has been described assuming the case where the location of the operator is detected using the motion detectors 8001, it is also possible to use a door opening/closing switch and detect the location of the operator when an exterior door is opened. Alternatively, it is also possible to recognize the location of the operator by image recognition using a camera. In addition, although FIG. 9 has been described taking the case where a paper jam occurs as an example, the present invention is not limited to this and is naturally also applicable to cases where, for example, toner exhaustion, no paper, or other errors occur.

As described above, according to Embodiment 1, when an error occurs, it is possible to judge whether the location of the operator is a proper location in light of the procedure of the recovery operation and to warn the operator by speech, display, or the like if that location is not a proper location. Thus, the operator is prevented from following an erroneous procedure when performing the operation for recovering from the error, and accordingly the occurrence of trouble such as damage to the paper during the recovery from the error can be prevented. Moreover, the operation efficiency of the operator can thus be increased.

### Embodiment 2

In Embodiment 1 above, the MFP 100 detects the location of the operator and judges whether the detected location is a proper location in light of performing the operation for recovering from an error. However, it is also necessary to further consider cases where the warning to the operator cannot be issued properly due to a malfunction of the motion detectors 8001 or the like as well as situations in which, even in the same unit, jammed paper may be torn if an incorrect processing sequence is followed.

Therefore, in Embodiment 2, a process for enabling the operator to properly perform the operation for clearing a jam will be described.

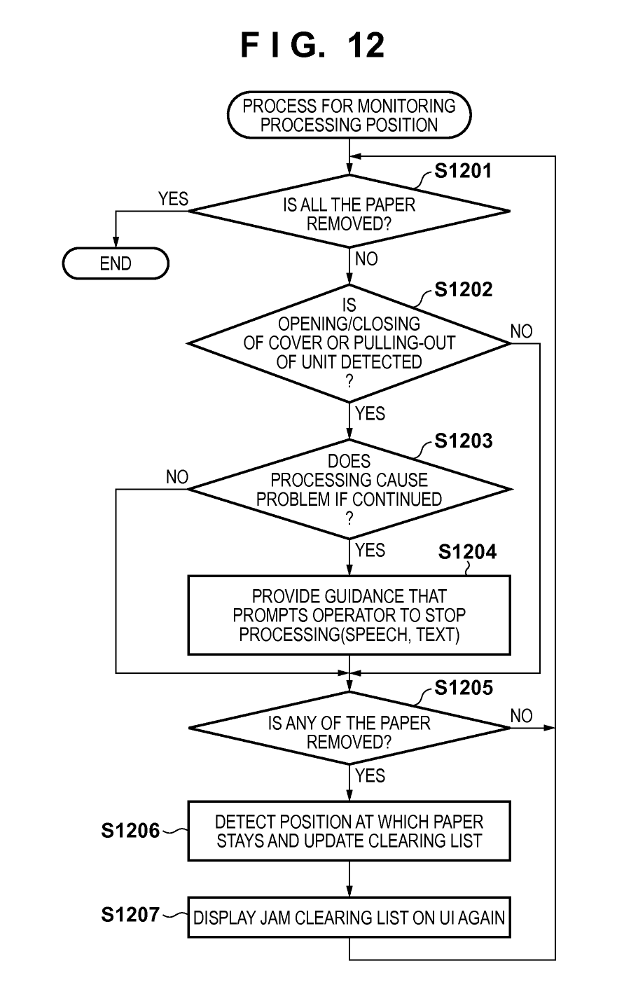

FIG. 12 is a flowchart for explaining a process that is performed by the MFP 100 according to Embodiment 2. Note that the process illustrated in this flowchart is achieved by the CPU 112 expanding in the RAM 113 and executing a program that is stored in the program ROM or the external memory 121.

First, in step S1201, the CPU 112 judges, based on signals from the sensors on the paper conveyance paths, whether all the jammed paper has been removed. If all the paper has been removed, the process is ended. If not, the process proceeds to step S1202, and the CPU 112 determines from which position the operator removes the jammed paper as the operation for recovering from the paper jam. Here, the MFP 100 is provided with a cover open/close sensor and a switch capable of sensing that an internal unit is pulled out, and thus the CPU 112 can specify the position at which the operator performs the operation. Then, the process proceeds to step S1203, and on detection of a change in the position at which operator performs the operation, the CPU 112 judges whether the operation should be continued at the changed position. The same table as in FIG. 11, which has been described in Embodiment 1 above, is used for this judgement, and the judging process is executed by an operation appropriateness judging unit 1008 in FIG. 10.

Now, in FIG. 11, with respect to the processing position “B1” in “unit B” for the operation ID “4”, “processing position A” in “unit B” is registered as the necessary preceding operation. This means that if paper is left at the processing position A in the printer unit B when an internal unit at the processing position B1 in the printer unit B is going to be pulled out, the operation for pulling out that internal unit should not be performed. If this order is not followed, a problem such as a tearing-off of the paper would occur.

In step S1203, if the CPU 112 judges that there would be no problem even if the operation is continued at that position, the process proceeds to step S1205, while if it is judged that a problem would occur, the process proceeds to step S1204, and the CPU 112 warns the operator that he/she should stop the operation by speech via the speech synthesis unit 123. At the same time, the warning may also be displayed on the operating unit 120. This process is executed by a unit 1007 for warning against continuation of operation in FIG. 10. Subsequently, the process proceeds to step S1205, and the CPU 112 again checks whether any of the jammed paper has been removed, and if none of the jammed paper has been removed, the process proceeds to step S1201, while if any of the jammed paper has been removed, the process proceeds to step S1206. In step S1206, the CPU 112 updates information on the clearing list based on information on the position at which a change has been detected. Then, the process proceeds to step S1207, and the CPU 112 updates the clearing list that is displayed on the operating unit 120. After that, the process returns to step S1201, and the above-described processing is repeated until all the jammed paper is removed.

As described above, according to Embodiment 2, the occurrence of a situation in which, for example, the warning to the operator cannot be issued properly due to a malfunction of the motion detectors can be prevented by determining the location of the operator by detecting the position at which the operator performs an operation, instead of using the motion detectors.

Note that although the above embodiment has been described assuming the case of a paper jam, the present invention is not limited to a paper jam as described above and is also applicable to cases of toner exhaustion, ink exhaustion, no paper, or other errors.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-239235, filed Nov. 19, 2013, which is hereby incorporated by reference herein in its entirety.

What is claimed is:

1. An image forming apparatus comprising:
a sensing unit configured to sense a location of an operator;
a detecting unit configured to detect an occurrence of an error;
a storing unit configured to store a procedure for recovering from the error;
a comparing unit configured to compare, in a case where the detecting units detects the occurrence of the error, a location of the operator that is indicated by the procedure stored in the storing unit with the location of the operator that is sensed by the sensing unit; and
a warning unit configured to issue a warning in a case where, as a result of comparison by the comparing unit, the location of the operator that is indicated by the procedure and the location of the operator that is sensed by the sensing unit do not match.

2. The image forming apparatus according to claim 1, further comprising:
a displaying unit configured to display, in a case where the detection unit detects the occurrence of the error, the procedure for recovering from the error.

3. The image forming apparatus according to claim 2, wherein the displaying unit displays the procedure as a list in which positions at which operations should be performed and an order of the operations are listed according to priority.

4. The image forming apparatus according to claim 1, wherein the warning unit issues the warning by speech.

5. The image forming apparatus according to claim 4, wherein the warning unit further notifies the operator of a correct procedure by speech.

6. The image forming apparatus according to claim 1, wherein the sensing unit uses a motion detector to sense the location of the operator.

7. The image forming apparatus according to claim 1, wherein the sensing unit uses a sensor for a door that is opened/closed by the operator and a sensor for a unit to be pulled out by the operator to sense the location of the operator.

8. The image forming apparatus according to claim 1, further comprising:
a notifying unit configured to notify, in a case where, as a result of comparison by the comparing unit, the location of the operator that is indicated by the procedure and the location of the operator that is sensed by the sensing unit match, the operator of the procedure for recovering from the error, wherein the procedure is performed at the location of the operator.

9. A method for controlling an image forming apparatus, the method comprising:
sensing a location of an operator;
detecting an occurrence of an error;
comparing, in a case where the occurrence of the error is detected in the detecting step, a location of the operator that is indicated by a procedure for recovering from the error, the procedure being stored in a memory, with the location of the operator that is sensed in the sensing step; and
issuing a warning in a case where, as a result of comparison in the comparing step, the location of the operator that is indicated by the procedure and the location of the operator that is sensed in the sensing step do not match.

10. A non-transitory computer-readable storage medium storing a program for causing a computer to execute the steps of the control method according to claim 9.
